(19) United States
(12) Patent Application Publication
(10) Pub. No.: US 2010/0104309 A1
(43) Pub. Date: Apr. 29, 2010

(54) SYSTEMS AND METHODS FOR STEPPED ENERGY SAVING MODES FOR A PRINTING DEVICE

(75) Inventor: Andrew Rodney Ferlitsch, Camas, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/260,805

(22) Filed: Oct. 29, 2008

(51) Int. Cl. G03G 15/20

(52) U.S. Cl. 399/70

(57) ABSTRACT

A method for stepped energy savings for a printing device is described. A temperature of a fuser of a printing device is reduced to a first reduced temperature after a first idle interval has passed in which there is no printing activity at the printing device. The first reduced temperature is calculated to be a temperature from which the fuser can be raised to an operating temperature in a first specified percentage of the full power up time. The full power up time being the time required to change the fuser from an ambient temperature to the operating temperature. If there is no printing activity during the first idle interval and a second idle interval, the fuser of the printing device is reduced to a second reduced temperature.

### TECHNICAL FIELD

The present invention relates generally to electronic devices and computer-related technology. More specifically, the present invention relates to systems and methods for stepped energy saving modes for a printing device.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, or a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals, a printer pool, a printer cluster, a fax machine, a plotter, a scanner, a logical device, an electronic whiteboard, a tablet PC, a computer monitor, a file, etc.

Different kinds of computer software facilitate the use of imaging devices. The computer or computing device that will be used to print the materials typically has one or more pieces of software running on the computer that enables it to send the necessary information to the printer to enable printing of the materials. If the computer or computing device is on a computer network there may be one or more pieces of software running on one or more computers on the computer network that facilitate printing.

Imaging devices, computing devices and other electronic devices all use power for operation. In some situations, it may be desirable to save power, while at other times the use of power may not be a concern. Benefits may be realized by providing improved systems and methods for controlling power usage on a device.

### BRIEF DESCRIPTION OF THE DRAWINGS

FIG. 1 is a block diagram illustrating one embodiment of a multi-function peripheral (MFP), one type of a printing device, utilizing stepped energy savings;

FIG. 2 is a block diagram illustrating one embodiment of an input panel showing potential stepped power saving settings for a printing device;

FIG. 3 is a chart showing exemplary fuser temperatures relative to time for a printing device, which employs stepped energy savings, in continuous use;

FIG. 4 is a chart illustrating exemplary fuser temperatures relative to time in which a printing device utilizing stepped energy savings is continuously idle;

FIG. 5 is a chart illustrating exemplary fuser temperatures relative to time for a printing device which is sporadically used;

FIG. 6 is a flow chart illustrating one embodiment of a method for stepped energy savings;

FIG. 7 is a flow chart illustrating another embodiment of a method for stepped energy savings;

FIG. 8 is a block diagram illustrating the major hardware components typically utilized with embodiments herein; and

FIG. 9 is a network block diagram illustrating one possible environment in which the present systems and methods may be implemented.

### DETAILED DESCRIPTION

A method for stepped energy savings for a printing device is disclosed. A temperature of a fuser of a printing device is reduced to a first reduced temperature after a first idle interval has passed in which there is no printing activity at the printing device. The first reduced temperature is calculated to be a temperature from which the fuser can be raised to an operating temperature in a first specified percentage of the full power up time. The full power up time is the time required to change the fuser from an ambient temperature to the operating temperature.

The temperature of the printing device is reduced to a second reduced temperature after the first idle interval and a second idle interval have passed in which there is no printing activity at the printing device. The second reduced temperature is calculated to be a temperature from which the fuser can be raised to the operating temperature in a second specified percentage of the full power up time. The second reduced temperature is less than the first reduced temperature. The temperature of the fuser is raised to the operating temperature in response to imaging activity at the printing device during the first and second idle intervals.

One embodiment may include three or more idle intervals. After the three or more idle intervals have passed in which there is no printing activity at the printing device, the fuser is reduced to an ambient temperature.

Heuristics may be utilized to control a time period of the first and the second idle intervals and/or to specify the first and the second specified percentages. In one configuration, the heuristics are based on usage data and/or specified objectives. The specified objectives may include, for example, maximum power savings and maximum print speed.

Also, the first and second idle intervals change based on a day of a week and/or a time of a day.

A printing device for stepped energy savings is also disclosed. The printing device may include a processor, a fuser, and memory in electronic communication with the processor. Instructions stored in the memory may be executable to perform stepped energy savings. A computer-readable medium providing for stepped energy savings for a printing device is also disclosed.

Several exemplary configurations are now described with reference to the Figures. This detailed description of several configurations, as illustrated in the Figures, is not intended to limit the scope of the claims.

The word “exemplary” is used exclusively herein to mean “serving as an example, instance, or illustration.” Any configuration described as “exemplary” is not necessarily to be construed as preferred or advantageous over other configurations.

The present systems and methods relate to power management of an electronic device. Different kinds of electronic devices may benefit from the systems and methods disclosed herein. For example, systems and methods herein may relate to power management of printing devices, which may include a multifunction peripheral (MFP) device. A current area of interest is making an MFP more “green” (i.e., energy and resource conserving). In particular, one area of high interest is managing the overall energy usage of the MFP.

In one embodiment, power usage may be conserved in an MFP by powering down the electromechanical components (e.g., fuser, developer) after some predetermined idle period. In such an embodiment, an MFP may have an administrative interface for setting an idle sleep period. If the idle sleep period expires (e.g., 1 hour) without any use of the electromechanical components (e.g., print engine), the MFP is powered down to a low-power usage standby (sleep) mode. The MFP then stays in this mode until the next usage. When the MFP is activated again, the MFP goes through a warm-up cycle (e.g., 15 to 60 seconds) to fully power up all the electromechanical components. The user for this first job must wait until the warm-up cycle passes.

One problem with this method is that it typically does not save much or any energy during the workday. The idle sleep period is typically set long enough to not be disruptive during the day with frequent full power down/up cycles. Thus, for the most part, these types of devices typically only power down after the end of the workday, and then only after the idle sleep interval passes. An equivalent savings can generally be obtained simply by using a scheduled power down solution whereby the device is powered down at a specified time of day.

One method, a partial power down method, only partially powers down the fuser of an MFP (i.e., greater than ambient temperature). The fuser, during power down, is kept heated to a level such that the time needed to raise the fuser to a fully heated state is equal or less than the time required to power up the remaining electromechanical components.

One advantage of this method is that power can be saved during normal operational periods without cyclically fully powering down/up the MFP. The operator is simply inconvenienced by the time to power up the non-fuser electromechanical components.

The stepped power saving method disclosed herein combines aspects of using an idle sleep period along with stepped, partial power down of a fuser component. This combination produces a novel, beneficial, and unexpected result.

Simply continuously powering down the MFP, or even partially powering down the MFP, has at least two negative factors:
Significant inconvenience to the user of constantly waiting for the power up cycle; and
Overhead and wear from continuously restarting the heating of the fuser from the ambient temperature.

Through the stepped energy saving systems and methods, the following benefits are obtained:
Substantial power savings, greater than a simple idle sleep mode, which are comparable to the partial power down method;
Substantial reduction on stress/wear on the fuser from reheating; and
Minimal inconvenience on wait times to power up with less overall time waiting than the partial power down method and near comparable wait times to the fixed idle period methods.

In summary, stepped energy saving systems and methods benefit from substantial energy saving increases with only a nominal increase in waiting time for power up over a long interval of time. Even in the post-workday (continuously idle), the stepped energy saving systems and methods benefit from increased energy savings over both the fixed idle sleep period method and other methods, with minimal or no increase in inconvenience.

The stepped energy saving systems and methods use a gradual (e.g., step) reduction of power level of the fuser over a fixed idle sleep period. In one simple example, assume an MFP's idle sleep period is set to 1 hour. The device may be configured with four power reduction steps (e.g., 15, 30, 45, and 60 minutes). In one scenario, the MFP is continuously idle over the entire idle sleep period. At the first interval (25% of period), the MFP partially powers down to a reduced power state whereby the reduced power state would power up to a full power state within 25% of the time it would take from a full powered down state.

At the second interval (50% of period), the MFP powers down to the next lower reduced power state (e.g., 50% time to repower). At the third interval (75% of period), the MFP powers down to the next lower reduced power state (e.g., 75% time to repower). Finally, at the final interval (100% of period), the MFP powers down to the fully powered down (sleep) state.

In this scenario, over a continuously idle period, the MFP saved about 50% of its energy consumption relating to the fuser, while achieving a fully powered down state after the fixed idle sleep period has expired. Note, in the traditional fixed sleep period method, no power would be saved during the fixed idle sleep period.

In another scenario, the MFP device may be used continuously. In this scenario, the device does not stay idle long enough to reach a first interval period. As a result, power consumption savings (none) and additional wait time (none) are the same as the fixed idle sleep method.

In such a scenario, in contrast to the stepped energy saving systems and methods, the partial power down method would cause the MFP to experience numerous partial power ups and downs with a high level of interruption. Further, under this method very little time is spent in power down mode, resulting in very little energy savings. Also, by the constant initiating and aborting the reduced power sequence, the fuser and associated parts suffer a substantial increase in exposure to wear and tear with likely noticeable, continuous time delays to the operator. Even in modes when a partial power down method is interrupted without any real reduction in fuser temperature, the simple switch from power down to full power and verification of a stable fuser temperature will result in measurable time overhead.

In a third scenario, the MFP may be used sporadically. In this mode, the idle periods fluctuate from exceeding an interval period and not exceeding an interval period, but never exceeding the fixed idle sleep period. As explained earlier, the fixed idle sleep method would not achieve any power savings in this scenario, though it would not suffer any time delays.

With the stepped energy savings systems and methods, some power savings would be achieved during the sporadic idle periods that exceed an interval period. Assuming that these idle periods are few or far apart, the MFP generally operates at or near the full fuser heat temperature, and thus the accumulated wait time over a long period is fairly minor.

The stepped energy saving methods can achieve even further improvements in energy savings or wait delays by heuristically tuning both the interval period (e.g., shorter vs. longer) and step down function (e.g., fixed vs. variable amount). For example, a printer utilization process could monitor an MFP device over a period of time to form a heuristic graph of usage on particular days or times. In one example, the interval period is lowered (i.e., step down sooner) for heuristically lower usage periods and lengthened (i.e., less time to power up) during heuristically lower usage periods.

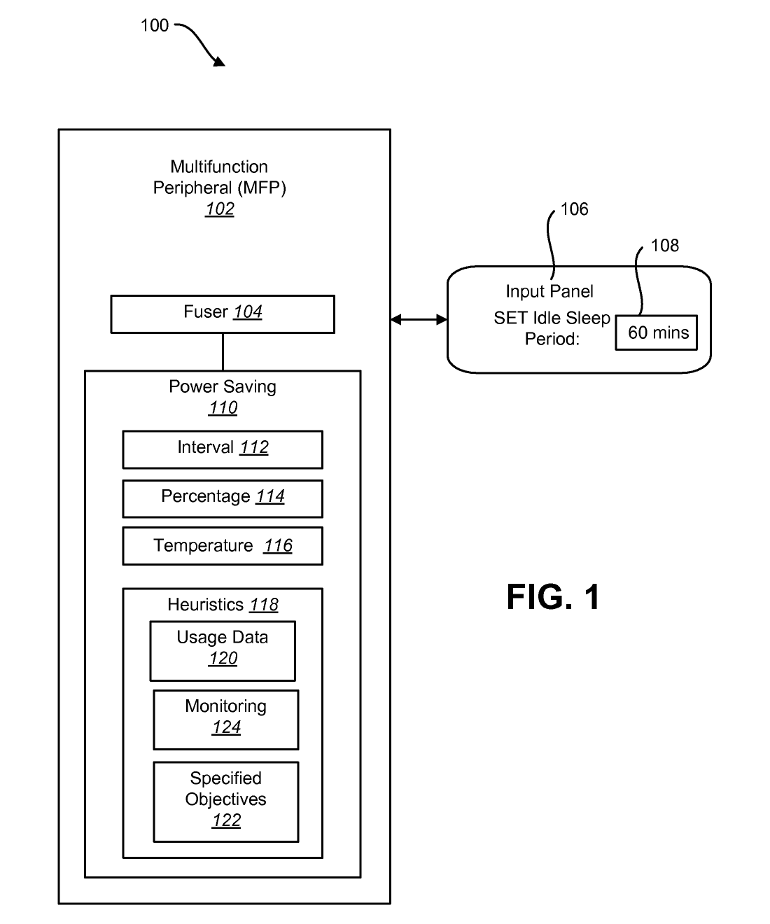

FIG. 1 illustrates an exemplary operating environment 100 in which the disclosed systems and methods of stepped power savings may be utilized. This environment may include one or more MFPs 102 with a fuser 104 (i.e., laser print engine). The fuser 104 is the part of the MFP that melts the toner onto the paper, or other substance that the MFP may be printing on. The fuser 104 accounts for much of an MFP's power usage. The MFP 102 may comprise a printing device. The MFP 102 has the capability of powering down the fuser 104 to ambient temperatures during a power save mode.

Additionally, an input panel 106 of the MFP 102 is provided to set an idle sleep period 108. In one embodiment, the input panel 106 may be accessed remotely, such as via remote computer system or server, and/or may be accessed through a user interface at the MFP 102.

The MFP 102 may include a number of different modules and components. For example, as illustrated in FIG. 1, the MFP 102 may include the fuser 104, as noted above, and a power saving module 110. The fuser 104, when heated to an operating temperature, fuses toner to a printing media, such as paper.

The power saving module 110 may include, for example, an interval module 112, a percentage module 114, a temperature module 116, and a heuristics module 118. The interval module 112 may receive, store, and/or compute the number of power saving intervals and the period of time for each interval. The number of intervals may vary within the scope of the disclosed systems and methods, such as such as utilizing two or more intervals. Upon the termination of each interval in which there is no printing activity, the MFP 102 is transitioned to a new power saving state (i.e., the temperature of the fuser is reduced). The time period for each interval may be specified by user input or may be controlled by a module, such as by a heuristics module 118. In one embodiment, the time period for each interval is the idle sleep period divided by four. Also, in one embodiment, the interval module 112 may include a timing mechanism to track the time in which the MFP 102 is in a particular power saving state.

For each of the reduced power levels, the percentage module 114 specifies a percentage of the full power up time required to raise the temperature of the fuser 104 from the pertinent reduced power level to an operating temperature. The full power up time is the time required to raise the fuser 104 from an ambient temperature to an operating temperature. The operating temperature is the temperature at which the fuser 104 can properly fuse toner to a printing medium. The ambient temperature may be a temperature specified by a manufacturer of an MFP 102 for purposes of calculating a full power up time or may be the actual temperature of the environment in which the MFP 102 is operating, as determined by temperature sensor.

The power saving module 110 may also include a temperature module 116. The temperature module 116 calculates the target temperature of the fuser 104 for a particular power saving level (i.e., the target temperature after each interval has passed without printing activity). For example, the temperature module 116 may calculate target temperatures for each power saving level based on the specified intervals and percentages. The temperature module 116 may also include electronic components for controlling and ascertaining temperature of the fuser 104.

The MFP 102 may be configured to use different idle sleep periods 108, interval time periods, and/or different power reduction steps (different percentages) for different days of the week, month, or year or for different times of the day.

For example, in a 9 a.m. to 5 p.m. office environment, it may be presumed that printing is extremely infrequent before 9 a.m. and after 5 p.m. and on weekends. For these time periods/days, a different power savings configuration may be set. For example, it might be desirable to have a substantially shorter sleep idle period 108 (e.g., 15 vs. 60 minutes) and a steeper progression in power reduction.

In another example, at certain times of day, on certain days, and/or on days of the month, printing may be very voluminous. One could consider two types of strategies:
Lengthen interval time periods (e.g., fewer intervals and/or longer idle sleep period 108) to reduce power downs during brief periods of lull; and/or
Reduce the step down (e.g., reduce percentages) to minimize the time to warm up after a brief lull period.

A heuristics module 118 may also be used. The heuristics module 118 may be utilized to compute the number of intervals, the time periods for each interval, percentages associated with each interval, and/or specified temperatures based on usage data 120. For example, the heuristics module 118 may control and alter the intervals, percentages, and specified temperatures based on day of the week (such as a weekday versus a weekend), time of day, and/or day of the month based on usage data 120 and specified energy saving objectives 122 (such as maximizing power saving or maximizing print speed). The heuristics module 118 would evaluate the collected usage data 120 along with its adaptive scheduling methods to maximize achieving a specified objective 122.

An example of specified objectives 122 could include:
Maximize the amount of power saved;
Constraint: average time warming up does not exceed 50%; and
Exception: 9 a.m.-9:30 a.m. Monday through Friday.

In one embodiment, the heuristics module 118 may include an internal or external monitoring module 124 that records and produces a heuristic profile of the MFP's 102 print usage over time and day.

The monitoring module 124 may be, for example, either:
Internal to the MFP 102 (e.g., firmware);
On-board process running in a guest operating system or environment (e.g., Java Virtual Machine) on the MFP 102;
External process on a server that is communicatively coupled to the MFP 102; and/or
Remote process provided as a service via the Internet.

The monitoring module 124 may be, in one embodiment, event driven. In such an embodiment, the monitoring process is configured to receive either real-time or periodic summary data. In the case of real-time, an event is generated either on a per output paper sheet basis or per output job basis. The event information may be passed to the process (either internal or external) in either binary or text form. In one example, the information is passed in an XML format, such as:

<print-engine-event start=“timeofday” end=“timeofday”/>

In the case of periodic summary, an event may be generated once a day (e.g., midnight) to summarize all jobs that utilized the print engine that day. For example, the event data may appear as:

```
<print-engine-summary-event date=”date”>
  <print-engine-event start=”timeofday” end=”timeofday” />
  ...
  <print-engine-event start=”timeofday” end=”timeofday” />
</print-engine-summary-event>
```

The monitoring module 124, in one embodiment, may also monitor the print engine usage of an MFP 102 by polling. A multitude of polling techniques can be used with varying accuracy, including the following examples.

In one embodiment, the MFP 102 is continuously polled to determine if the print engine is busy (i.e., printer status request). The polling period is generally kept short for accuracy, such as on 30-second intervals. The status of the print engine (idle vs. busy) is then charted out over the period of interest (e.g., day) and the status of the print engine is assigned to the whole poll period for each period polled.

In a second example, the MFP 102 sporadically polls the MFP 102 for a job history. Information from the job history (start and end times of jobs) is then used to chart out the usage of the print engine during the period of interest (e.g., day). In systems where only cruder information is available, the printer usage data can be estimated using predetermined information on the outputting capabilities of the print engine. For example, the MFP 102 can be polled every 15 minutes for a total print count. If the change in print count from the last interval is zero, the entire period is set as idle. Otherwise the period will be split into a non-idle and idle period. The percentage that is non-idle can be estimated by the number of sheets outputted during the period multiplied by the outputting engine speed.

After collecting print usage information over a passage of time (e.g., one week), the heuristic module 118 may then adapt the idle sleep period 106 settings according to the collected usage data 120.

The heuristic module 118 may then use the collected usage data 120 and, through a usage verses sleep simulator, simulate varying patterns to determine an optimal or near optional scheduling of idle sleep periods 108 and settings.

Each of the modules 112, 114, 116, 118 of FIG. 1 may operate within the MFP 102 or may be located external to the MFP 102, such as through a remote server. Also, default values for each of these modules 112, 114, 116, 118 may be specified, for example, by a manufacturer of the MFP 102, a reseller, distributor, or an end-user of the MFP 102.

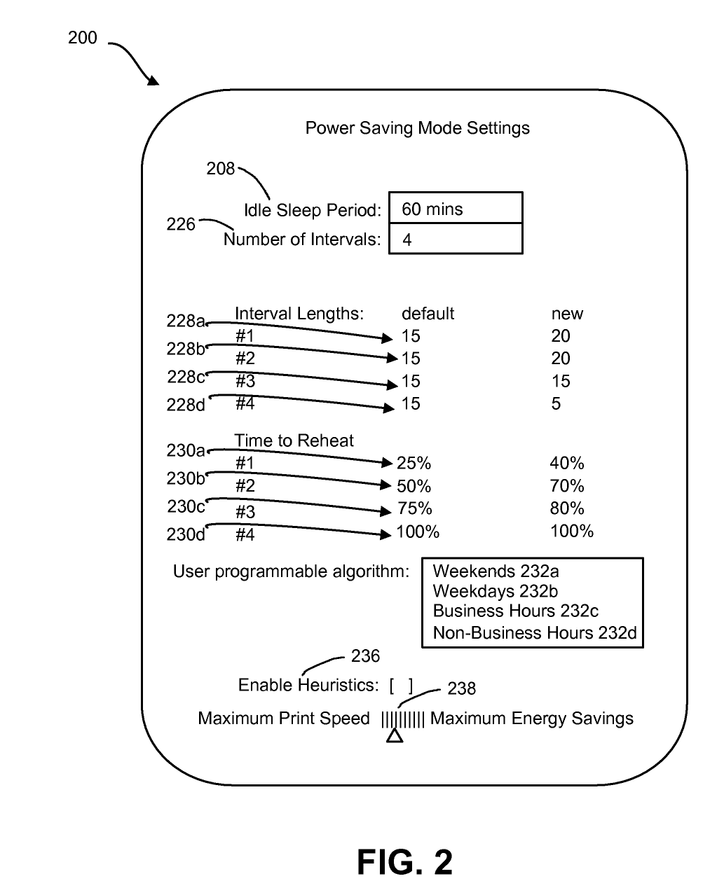

FIG. 2 illustrates one embodiment of an input panel 200 for controlling powers saving settings. In the illustrated embodiment, an administrator first sets a power saving policy for one or more MFPs 102. This may be done as a walkup or remote (e.g., embedded web page) operation on a per MFP 102 device, or maybe administratively handled through a central printer administration program that is communicatively coupled with multiple MFPs 102.

The configurable settings may include at least the following:
Setting of an idle sleep period 208; and
Setting of the number of intervals 226 per idle sleep period 208.

An input panel 200 may also have additional finer control options, including:
Setting variable lengths 228 for the intervals 226, including, for example, a first idle interval 228a, a second idle interval 228b, a third idle interval 228c, and a fourth idle interval 228d;
Setting non-proportional percentages 230, including, for example, a first specified percentage 230a related to the first idle interval 228a, a second specified percentage 230b related to the second idle interval 228b, a third specified percentage 230c related to the third idle interval 228c, and a fourth specified percentage 230d related to the fourth idle interval 228d;
Setting different idle sleep periods/interval 208 for different days of the week or month and times of day (e.g., different idle sleep periods/intervals 208 for weekends, weekdays, business hours, and non-business hours 232a-d); and
Using a heuristics (employing an exemplary user interface 236 to enable heuristics) to dynamically set and change over time the settings based on usage, energy savings, and degree of inconvenience (i.e., maximum print speed v. maximum energy savings 238).

The input panel 200 provides only one example of many different types of input panels 200 that could provide for stepped energy savings for an MFP 102 or other printing device.

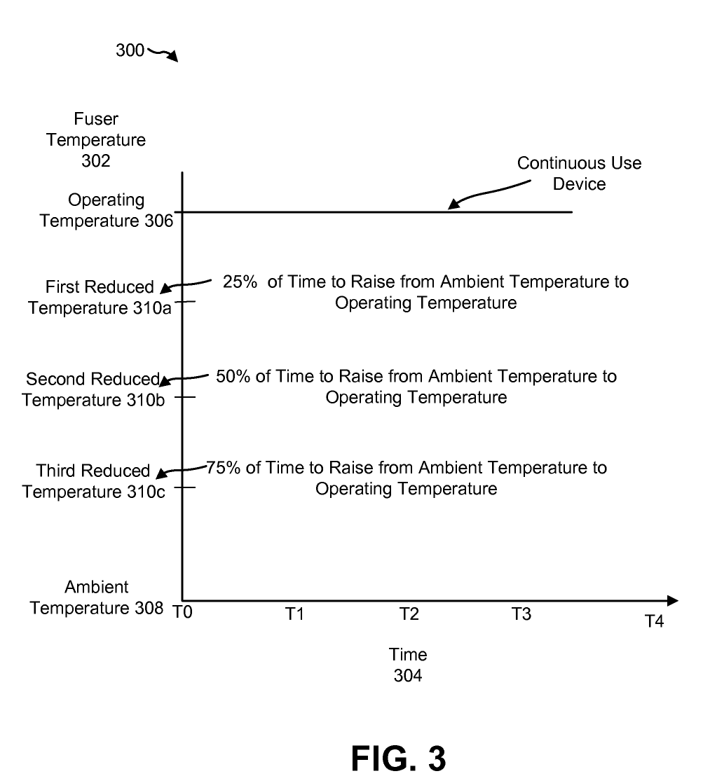

FIG. 3 is one embodiment of a chart 300 illustrating the fuser temperature 302 relative to time 304 (T0, T1, T2, T3, and T4) utilizing systems and methods for stepped power saving. In the illustrated embodiment, the MFP 102, or other printing device, is continuously used or is at least not idle for a period of time in excess of the first interval period 228a.

A power saving mode has been configured and set, as described, for example, with respect to FIG. 2. In the illustrated example, the usage of the print engine is at or near continuous throughout an idle sleep period 208 (e.g., 60 minutes).

Since the print engine is either not idle or always idled less than the first interval period 228a, the fuser 104 is always powered at the operating temperature 306. No power savings are achieved during these periods, and no overhead waiting for power up is experienced by users.

In the example shown in FIG. 3, a first specified percentage 230a is 25%, a second specified percentage 230b is 50%, and a third specified percentage 230c is 75%. In such an embodiment, it would require 25% of the full power up time (i.e., the time required to raise the fuser 104 from the ambient temperature 308 to the operating temperature 306) to proceed from the first reduced temperature 310a to the operating temperature 306. Likewise, it would require 50% of the full power up time to raise the fuser 104 from the second reduced temperature 310b to the operating temperature 306, and 75% of the first power up time the time to raise the fuser 104 from the third reduced temperature 310c to the operating temperature 306.

It should be noted here that neither the chart 300 of FIG. 3 nor any of the charts of this application are drawn to scale. In other words, the operating temperature 306, the first reduced temperature 310a, second reduced temperature 310b, third reduced temperature 310c, and the ambient temperature 308 may not be an equal number of degrees of temperature apart.

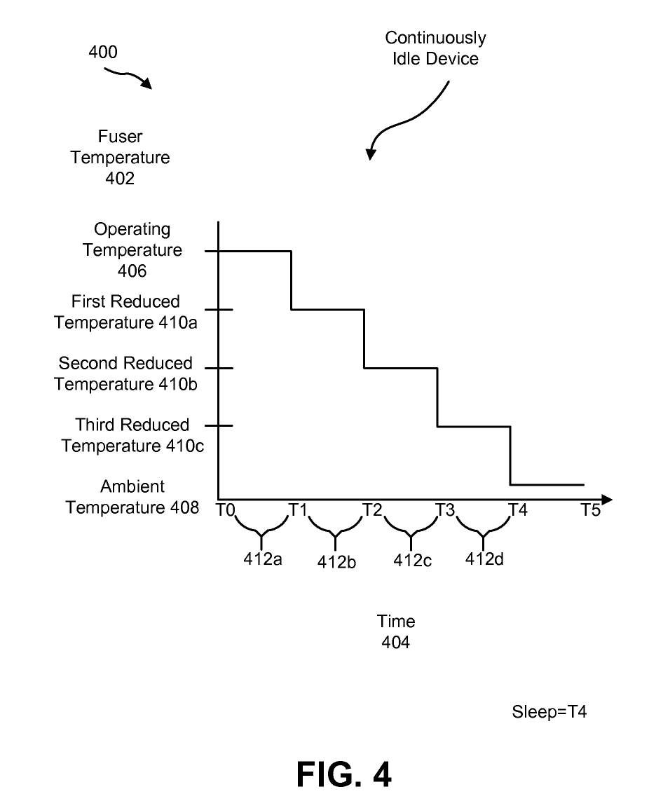

FIG. 4 illustrates one embodiment of a chart 400 showing the fuser temperature 402 relative to time 404 for a printing device, or an MFP 102, that is continuously idle through the first, second, third, and fourth idle intervals 412a-d.

In this example, the fuser temperature 402 will be reduced as each interval 412a-d has elapsed. In one example, the idle sleep period 208 is set to 60 minutes with 4 equal 15 minute intervals 412a-d, and a proportional increase in reheat time. For illustrative purposes only, it will be assumed that the reheat time from ambient temperature 408 to fuser operating temperature 406 is 60 seconds.

After the expiration of the first idle interval 412a (15 minutes), the power level to the fuser 104 is reduced by an amount that lowers the fuser temperature 402 a first reduced temperature 410a. The first reduced temperature 410a is temperature whereby raising the fuser from this first reduced temperature 410a to the operating temperature 406 is 25% (e.g., 15 seconds) of the full power up time, which is the time to raise the temperature of the fuser 104 from the ambient temperature 408 to the operating temperature 406.

After the expiration of the second idle interval 412b (e.g., 30 minutes), the power level to the fuser is reduced to the second reduced temperature 410b. The second reduced temperature 410b is a temperature whereby raising the fuser 104 from this second reduced temperature 410b to the operating temperature 406 requires at least 50% (e.g. 30 seconds) of the full power up time.

After the expiration of the third idle interval 412c (45 minutes), the power level to the fuser 104 is reduced to the third reduced temperature 410c. The third reduced temperature 410c is a temperature whereby raising the fuser from this third reduced temperature 410c to the operating temperature 406 is 75% (e.g. 45 seconds) of the full power up time.

After the expiration of the final (fourth) interval 412d (60 minutes), the power to the fuser 104 is turned off or reduced, allowing the fuser temperature 402 to drop to the ambient temperature 408. Raising the fuser 104 from the ambient temperature 408 to the operating temperature 406 is 100% (e.g. 60 seconds) of full power up time.

In the example in FIG. 4, if the power consumed by the fuser 104 is proportionally equal to the time to raise the temperature to operating temperature 406, the fuser 104 power saved is approximately 45%. As the interval period approaches zero (infinite number of intervals 226), the power saved approaches the limit 50%. Thus, even a few long intervals 412a-d can achieve near optimal savings.

The embodiment shown in FIG. 4 is merely illustrative and may be varied within the scope of the disclosed systems and methods. For example, although four idle intervals 412a-d are illustrated in this figure, the number of idle intervals 412a-d may be varied within the scope of the disclosed systems and methods including, for example, an embodiment having three or more idle intervals 412a-d.

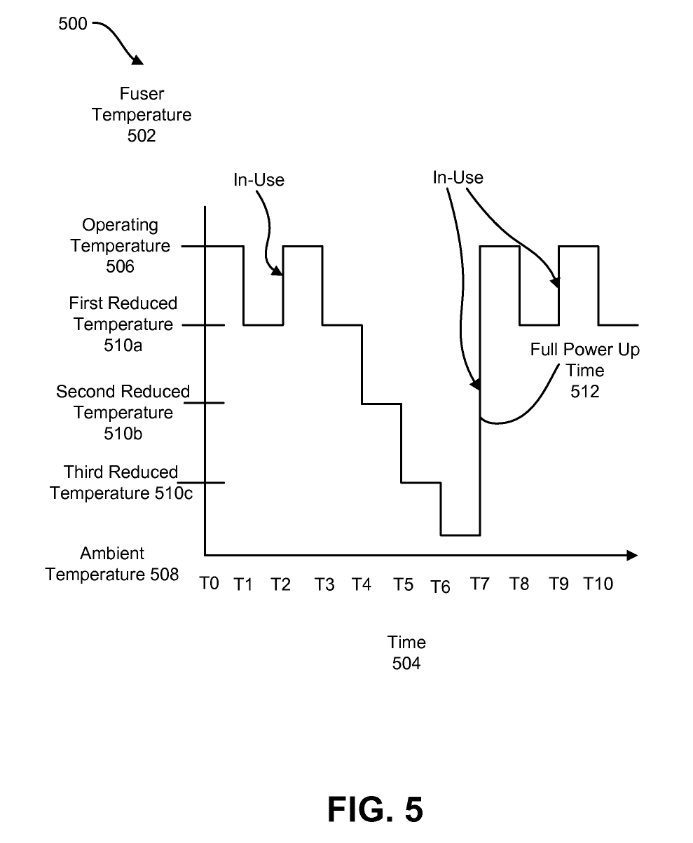

FIG. 5 illustrates one embodiment of a chart 500 showing the fuser temperature 502 relative to time 504 for a printing device that is sporadically used throughout an idle sleep period 208 (e.g., 60 minutes).

In the example shown in FIG. 5, some combination of the following cyclic events occur:
If the print engine is used before the interval period expires, the fuser remains at operating temperature 506;
If the print engine is not used during an interval period, the fuser temperature 502 is stepped down; and
If the sleep period is interrupted by the print engine use, the fuser 104 is reheated to operating temperature 506.

As shown by the example illustrated in FIG. 5, some power savings would be achieved during the sporadic idle periods, which exceed a first idle interval period 412a. Also, if these idle intervals 412a-d are few and far apart:
Some power saving will still be gained; and
Inconvenience to the users will be minimal, since reheating warm-ups will only occur once per period that exceeded an interval, and the fuser will already be near full-fuser temperature. Thus, the remaining warm-up time is only a fraction of the full warming time.

If these idle intervals are frequent with occasional print interruptions:
Power savings increase substantially towards the maximum savings limit (e.g., 50%); and
Inconvenience to the users will be minimal—only once per sporadic job that interrupts an idle period. The fuser temperature on average will be near a mean limit (50%). Thus, the remaining warm-up time is still substantially less than the full warming time.

With respect to FIG. 5, a full power up time 512 is illustrated. As noted above, the full power up time 512 is the time required to raise the fuser temperature 502 of the fuser 104 from the ambient temperature 508 to the operating temperature 506.

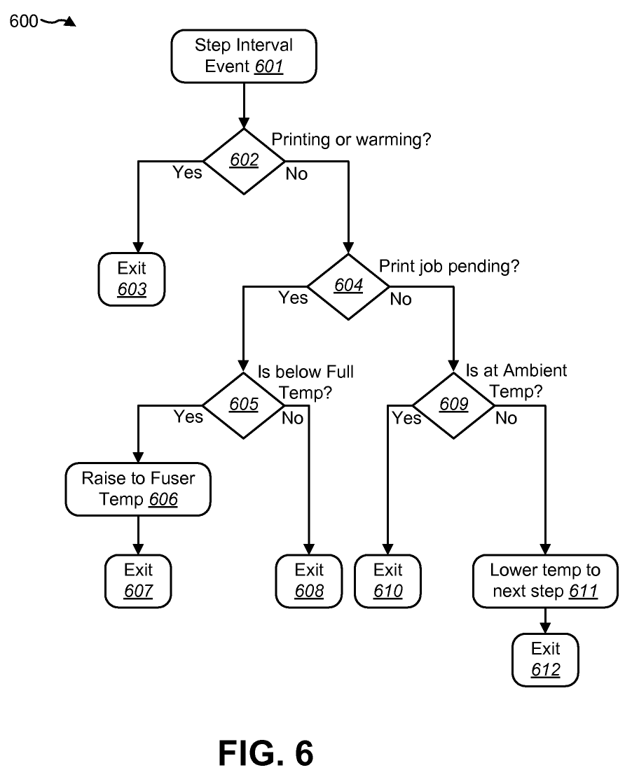

FIG. 6 is a flowchart 600 illustrating one embodiment of a method for stepped power savings for an MFP 102. At step 601 in FIG. 6, a step interval event occurs. For example, the event may be the expiration of the time period for the interval (such as a first or second idle interval). Step 602 determines if the printer is printing or warming up. If so (i.e., the fuser is already at full operating temperature (printing) or already warming up), no action is taken 603.

Otherwise, control moves to step 604 where a determination is made on whether a print job is pending. If a print job is pending, it is determined 605 if the fuser is at operating temperature. If not, the process to raise the fuser from the current temperature to the operating temperature is started 606. When fully reheated 607, the process exits and the pending job may start printing.

If it is determined at step 605 that the fuser is already at full temperature, the process exits 608 and the pending job may start printing.

If at step 604 it is determined that a print job is not pending, control moves to step 609 where a determination is made on whether the fuser is at ambient (unheated) temperature. If it is at full operating temperature, the process exits 610. Otherwise (the fuser is not at ambient temperature), control moves to process 611, which initiates lowering the fuser temperature to the temperature level associated with the interval.

Temperature of the fuser may be lowered by any means, such as:
Immediate cut-off of power until lower temperature is reached, followed by power restored to the power level associated with the target lower temperature;
Immediate reduction to the power level associated with the target lower temperature; and
Gradual reduction of power to the power level associated with the target lower temperature.

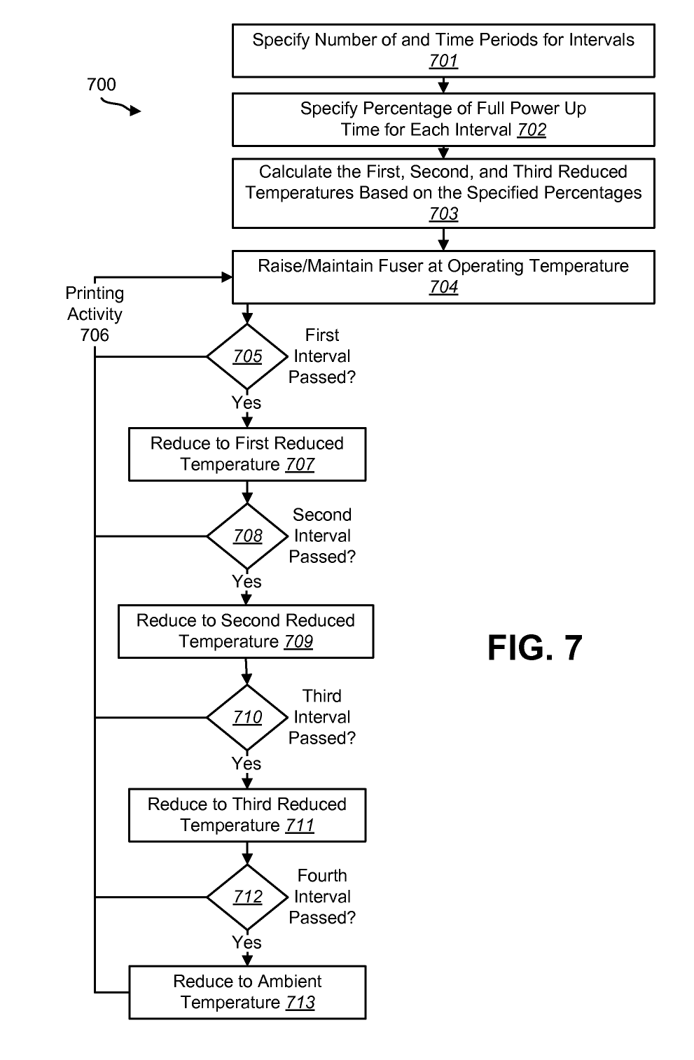

FIG. 7 is a flowchart illustrating one embodiment of a method 700 for stepped energy savings for a printing device. The number of intervals 226 and the time periods 228a-d for each of the intervals 412a-d are specified 701. Specification of time periods 701 for each of the intervals 412a-d and the number of intervals 226 is performed by a manufacturer of a printing device, which may include an MFP102.

As indicated previously, the time periods 228a-d for each of the intervals 412a-d may also be specified by a user through an input panel 200, either remotely or at the printing device. The time periods 228a-d for each of the intervals 412a-d may be uniform in time or may be different in length. Also, the time period 228a-d for each of the intervals 412a-d may be specified merely by inputting an idle sleep period 208 and the number of intervals 226 (i.e., each of the intervals 412a-d will be equal in time).

A percentage 230a-d of the full power up time 512 for each interval 412a-d may be also specified 702. As explained above, the full power up time 512 is the time required to raise the fuser temperature 502 from an ambient temperature 508, which may be a temperature specified by the manufacturer of the printing device or could be the actual temperature of the environment in which the printing device is situated. The operating temperature 506 is the temperature at which the fuser 104 may properly fuse toner to a printing medium.

Based on the specified percentages 228a-d, the first, second, and third reduced temperatures 510a-c may be calculated 703. Of course, other reduced temperatures 510a-c may be computed if a different number of intervals 226 are specified.

As explained herein, a heuristics module 118 may be utilized to specify the time period 228a-d of intervals 412a-d, the number of intervals 226, percentages 230a-d, or reduced temperatures 510a-c for specific intervals. Also, utilizing heuristics, or alternatively user input, the percentages 230a-d for intervals 412a-d, time periods 228a-d for intervals 412a-d, or reduced temperatures 510a-c may be specified for different times of the day, different days of the week, days of the month, days of the year, weekdays, and/or weekends.

Initially, the fuser 104 may be raised 704 to an operating temperature in response to turning the printing device on and/or in response to receipt of a print job and/or in response to receiving a warmup command either programmatically or activated by an environmental or behavioral sensor. If the first idle interval 412a passes 705 with no printing activity 706 begin detected, the temperature 502 of the fuser 104 is reduced 707 to the first reduced temperature 510a. Printing activity 706 may comprise, for example, printing of a document, or receipt of a print job at the printing device, notification that the print job will be sent to the printing device, or simply warming up the fuser 104 in response to receipt of a print job.

It is then determined whether the second interval 412b has passed 708 in which there is no printing activity 706. If the second interval 412a passes 708 with no printing activity 706, the fuser is reduced 709 to the second reduced temperature 510b.

It is then determined whether the third interval 412c has passed 710 without printing activity 706. If the third interval is passed 710 without printing activity 706, the fuser 104 is reduced 711 to the third reduced temperature 510c.

If the fourth interval 412d passes 712, the fuser 104 is reduced 713 to the ambient temperature 508, such as by supplying minimal or no power to the fuser 104. If printing activity 706 occurs at the printing device during either the first, second, third, or fourth idle intervals 412a-b, the fuser 104 is raised to or maintained 704 at the operating temperature 506. Once the printing activity has completed or immediately upon starting the printing activity, the interval periods 412a-d are restarted. In some cases, a print job request may be for a deferred outputting operation (e.g., a filing job). In these cases, an executing process in the MFP 102, or other printing device, is not considered a printing activity until a process requires the use of the electromechanical components (e.g., a fuser) which are controlled by the stepped energy savings systems and methods.

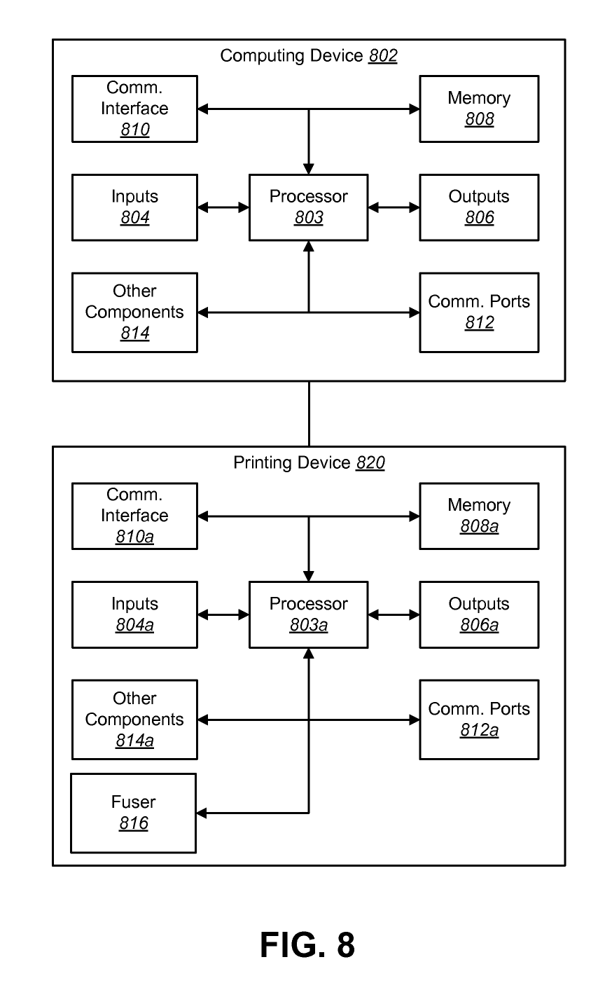

FIG. 8 is a block diagram illustrating the major hardware components that may be used with configurations herein. For example, the power regulating systems herein may be used with a printing device 820 in electronic communication with a computing device 802. The various processes herein, such as a peak/off-peak controller, the job queues, power save mode configurations, job classifier, etc., may be implemented on the printing device 820 (e.g., an MFP) and/or on the computing device 802.

The systems and methods disclosed may be used with a computing device 802 and a printing device 820. The major hardware components typically utilized in a computing device 802 are illustrated in FIG. 8. A computing device 802 typically includes a processor 803 in electronic communication with input components or devices and/or output components or devices. The processor 803 is operably connected to input 804 and/or output devices 806 capable of electronic communication with the processor 803, or, in other words, to devices capable of input and/or output in the form of an electrical signal. Embodiments of devices 802 may include the inputs 804, outputs 806, and the processor 803 within the same physical structure or in separate housings or structures.

The computing device 802 may also include memory 808. The memory 808 may be a separate component from the processor 803, or it may be on-board memory 808 included in the same part as the processor 803. For example, microcontrollers often include a certain amount of on-board memory.

The processor 803 is also in electronic communication with a communication interface 810. The communication interface 810 may be used for communications with other devices 802, printing devices 820, servers, etc. Thus, the communication interfaces 810 of the various devices 802 may be designed to communicate with each other to send signals or messages between the computing devices 802.

The computing device 802 may also include other communication ports 812. In addition, other components 814 may also be included in the computing device 802.

Many kinds of different devices may be used with embodiments herein. The computing device 802 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 8 is only meant to illustrate typical components of a computing device 802 and is not meant to limit the scope of embodiments disclosed herein.

The computing device 802 is in electronic communication with the printing device 820. A printing device 820 is a device that receives or transmits an imaging job, such as an MFP device or computing device. Printing devices include, but are not limited to, physical printers, multi-functional peripherals, a printer pool, a printer cluster, a fax machine, a plotter, a scanner, a copier, a logical device, a media duplication device, etc. A typical printing device, such as a physical printer, fax machine, scanner, multi-functional peripheral or copier is a type of computing device. As a result, it also includes a processor, memory, communications interface, etc., as shown and illustrated in relation to FIG. 8. The printing device may be a single or a plural grouping (e.g., pool or cluster) of two or more devices. The printing device may also include a fuser 816, which, utilizing heat, fuses toner to a printing medium, such as paper.

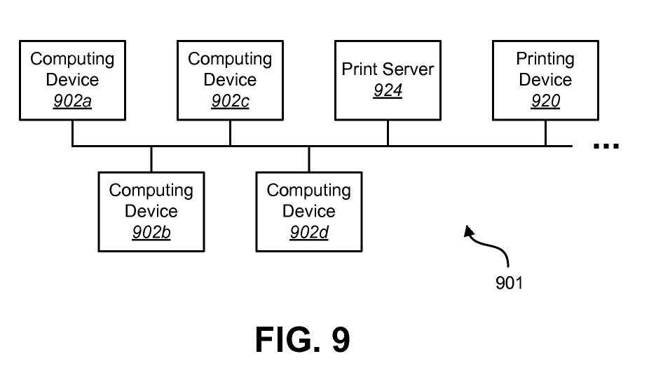

FIG. 9 is a network block diagram illustrating one possible environment in which the present systems and methods may be implemented. In particular, FIG. 9 illustrates a computer network 901 comprising a plurality of computing devices 902a-d, a printing device 920, and a print server 924.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

It is to be understood that the claims are not limited to the precise configuration and components illustrated above. Various modifications, changes and variations may be made in the arrangement, operation and details of the systems, methods, and apparatus described above without departing from the scope of the claims.

What is claimed is:

1. A method for stepped energy savings for a printing device, comprising:
reducing a temperature of a fuser of a printing device to a first reduced temperature after a first idle interval has passed in which there is no printing activity at the printing device, wherein the first reduced temperature is calculated to be a temperature from which the fuser can be raised to an operating temperature in a first specified percentage of the full power up time, the full power up time being the time required to change the fuser from an ambient temperature to the operating temperature;
reducing the temperature of the printing device to a second reduced temperature after the first idle interval and a second idle interval have passed in which there is no printing activity at the printing device, wherein the second reduced temperature is calculated to be a temperature from which the fuser can be raised to the operating temperature in a second specified percentage of the full power up time, the second reduced temperature being less than the first reduced temperature; and
raising the temperature of the fuser to the operating temperature in response to imaging activity at the printing device during the first and second idle intervals.

2. The method of claim 1, further comprising three or more idle intervals, wherein after the three or more idle intervals have passed in which there is no printing activity at the printing device, reducing the fuser to an ambient temperature.

3. The method of claim 1, further comprising utilizing heuristics to control a time period of the first and the second idle intervals.

4. The method of claim 1, further comprising utilizing heuristics to specify the first and the second specified percentages.

5. The method of claim 3, wherein the heuristics are based on usage data and specified objectives.

6. The method of claim 5, wherein the specified objectives include maximum power savings and maximum print speed.

7. The method of claim 1, wherein the first and second idle intervals change based on a day of a week.

8. The method of claim 1, wherein the first and second idle intervals change based a time of a day.

9. A printing device for stepped energy savings, the printing device comprising:
a processor;
a fuser;
memory in electronic communication with the processor;
instructions stored in the memory, the instructions being executable to:
reduce a temperature of a fuser of a printing device to a first reduced temperature after a first idle interval has passed in which there is no printing activity at the printing device, wherein the first reduced temperature is calculated to be a temperature from which the fuser can be raised to an operating temperature in a first specified percentage of the full power up time, the full power up time being the time required to change the fuser from an ambient temperature to the operating temperature;
reduce the temperature of the printing device to a second reduced temperature after the first idle interval and a second idle interval have passed in which there is no printing activity at the printing device, wherein the second reduced temperature is calculated to be a temperature from which the fuser can be raised to the operating temperature in a second specified percentage of the full power up time, the second reduced temperature being less than the first reduced temperature; and
raise the temperature of the fuser to the operating temperature in response to imaging activity at the printing device during the first and second idle intervals.

10. The printing device of claim 9, further comprising three or more idle intervals, wherein after the three or more idle intervals have passed in which there is no printing activity at the printing device, reducing the fuser to an ambient temperature.

11. The printing device of claim 9, further comprising utilizing heuristics to control a time period of the first and the second idle intervals.

12. The printing device of claim 9, further comprising utilizing heuristics to specify the first and the second specified percentages.

13. The printing device of claim 11, wherein the heuristics are based on usage data and specified objectives.

14. The printing device of claim 13, wherein the specified objectives include maximum power savings and maximum print speed.

15. The printing device of claim 9, wherein the first and second idle intervals change based on a day of a week.

16. The printing device of claim 9, wherein the first and second idle intervals change based a time of a day.

17. A computer-readable medium providing for stepped energy savings for a printing device, the computer-readable medium comprising executable instructions for:
reducing a temperature of a fuser of a printing device to a first reduced temperature after a first idle interval has passed in which there is no printing activity at the printing device, wherein the first reduced temperature is calculated to be a temperature from which the fuser can be raised to an operating temperature in a first specified percentage of the full power up time, the full power up time being the time required to change the fuser from an ambient temperature to the operating temperature;
reducing the temperature of the printing device to a second reduced temperature after the first idle interval and a second idle interval have passed in which there is no printing activity at the printing device, wherein the second reduced temperature is calculated to be a temperature from which the fuser can be raised to the operating temperature in a second specified percentage of the full power up time, the second reduced temperature being less than the first reduced temperature; and
raising the temperature of the fuser to the operating temperature in response to imaging activity at the printing device during the first and second idle intervals.

18. The computer-readable medium of claim 17, further comprising three or more idle intervals, wherein after the three or more idle intervals have passed in which there is no printing activity at the printing device, reducing the fuser to an ambient temperature.

19. The computer-readable medium of claim 17, further comprising utilizing heuristics to control a time period of the first and the second idle intervals.

20. The computer-readable medium of claim 17, further comprising utilizing heuristics to specify the first and the second specified percentages.
